(19) United States
(12) Patent Application Publication
(10) Pub. No.: US 2012/0234507 A1
(43) Pub. Date: Sep. 20, 2012

(54) SAFETY BOTTOM BRACKET FOR SECTIONAL DOORS

(75) Inventors: Michael G. Rauch, Abbotsford (CA); James A. Letkemann, Abbotsford (CA)

(73) Assignee: HELTON INDUSTRIES LTD., Abbotsford (CA)

(21) Appl. No.: 13/231,072

(22) Filed: Sep. 13, 2011

Related U.S. Application Data
(60) Provisional application No. 61/382,369, filed on Sep. 13, 2010.

(51) Int. Cl. E06B 5/00; B23P 11/00; E06B 7/00

(52) U.S. Cl. 160/201; 248/309.1; 29/426.1

(57) ABSTRACT

A safety bottom bracket for a sectional door is provided. The safety bottom bracket includes a frame, a cable attachment member coupled to the frame for attaching a cable to the bracket, and a slot in the frame for securing the bracket to the sectional door via a fastener passing through the slot. The slot has a tool-accessible portion, and a tool-inaccessible portion defined by one or more protrusions extending from or near the edges of the tool-inaccessible portion of the slot. When the bracket is connected to the cable under tension, the bracket is biased to a tensioned position where the fastener is located in the tool-inaccessible portion of the slot. When the bracket is not under tension or when the bracket is not connected to the cable, the bracket is movable to an untensioned position where the fastener is located in the tool-accessible portion of the slot.

### FIELD OF INVENTION

The present invention relates to sectional door assemblies. More particularly the present invention relates to safety bottom brackets for sectional doors.

### BACKGROUND OF THE INVENTION

Upward acting sectional doors commonly are counterbalanced by spring assemblies, which in turn are connected by a cable to either side of the door. The cables act to balance the door weight as the door is raised and lowered. The door sections are further supported by a series of rollers mounted to each section which are guided by a track structure. The cables are typically fastened to the bottom door section at the lower left and right hand corners by means of a bottom bracket (also known as a bottom fixture). The bottom bracket on a typical sectional door functions as the cable attachment as well as the bottom roller attachment.

Sectional doors periodically require maintenance. Maintenance to sectional doors may include replacing the bottom roller or may include some other type of repair to the door assembly. During such maintenance, it may be necessary to remove the bottom bracket. With conventional bottom brackets, removal of the bottom bracket is only safe after tension has been removed from the spring cable counterbalance system. Conventional bottom brackets are typically mounted to the door by lag screws or other removable fastening devices. If the cable tension has not been removed, when the last fastener has been removed, the springs unwind suddenly causing fasteners, the bracket, the roller, the cables and/or springs to become hazardous flying objects creating a dangerous situation for the repairmen, homeowner, or other persons or property nearby.

Due to the listed deficiencies in conventional methods for safe maintenance of sectional door assemblies, there exists a need within the industry for a bottom bracket that is safer than the conventional bottom bracket. Furthermore, an improved bottom bracket should be highly manufacturable and cost effective to produce.

### SUMMARY OF THE INVENTION

One aspect of the invention provides a safety bottom bracket which inhibits individuals from removing the bottom bracket while the bottom bracket is connected to a cable under tension, and thereby reduces the potential for injury to the persons who are performing maintenance on the sectional door.

One aspect of the invention provides a safety bottom bracket having one or more protrusions which function to impede access by tools to at least one fastener which secures the bracket to the sectional door. In some embodiments, the bracket may be substantially a one-piece bracket, which is simpler and more easily manufactured compared to two-piece brackets. In some embodiments, the bracket may be universal and installs easily to most commercially available sectional doors without any unique requirement for interconnection or interlock with the end stile of the bottom section or the bottom door section itself.

One aspect of the invention provides a safety bottom bracket that has a number of attachment apertures including a number of holes or slots. At least one slot functions as an initial attachment point for the bracket. The slot may comprise a tool-accessible portion and a tool-inaccessible portion. One or more protrusions may be provided on or near the edges of the tool-inaccessible portion of the slot. Once the initial fastener is assembled, the slot orientation allows the bracket to be slidably moved upwards by hammer or other forceful means, into the final installed position. In this position, the protrusions function to physically impede access by common mechanical tools to the fastener. Other fasteners may then be attached to further secure the bracket to the door.

According to this aspect of the invention, access to at least one fastener is inhibited while there is tension on the cable. When and only when the cable tension is removed, can the bracket be slidably moved downwards, aligning the fastener from the tool-inaccessible portion of the slot to the tool-accessible portion of the slot, which allows access to the last remaining fastener. Thus, the sectional door bottom bracket is prevented from detaching from the door when the bracket is attached to a cable under tension and all the other accessible fasteners are removed. As such, one aspect of the present invention provides an improved safety bottom bracket which reduces the likelihood of injuries for individuals working on or otherwise tampering with sectional door assemblies.

The safety bottom bracket may be provided with other features which permit other functions of the bottom bracket. These features may include a suitable means to attach the spring loaded cable, as well as means for attaching the roller.

One aspect of the invention provides a safety bottom bracket for a sectional door. The safety bottom bracket comprises a frame; a cable attachment member coupled to the frame for attaching a cable to the bracket; a slot in the frame for securing the bracket to the sectional door via a fastener passing through the slot, the slot having a tool-accessible portion and a tool-inaccessible portion; and one or more protrusions extending from or near the edges of the tool-inaccessible portion of the slot. In some embodiments, the frame comprises a generally L-shaped flange having a back planar surface and a side planar surface.

One aspect of the invention provides a sectional door assembly that comprises a safety bottom bracket that prevents removal of the bottom bracket from the sectional door assembly when the bottom bracket is connected to a cable under tension.

One aspect of the invention provides a sectional door assembly which comprises a plurality of interconnected sectional door panels; a pair of tracks for guiding the movement of the sectional door panels; one or more springs; a pair of cables connected to and operatively tensioned by the springs; a plurality of rollers attached to the sectional door panels and rollably received in the tracks; and a pair of safety bottom brackets that can be fastened to a bottom sectional door panel and releasably connected to the cables.

One aspect of the invention provides a method for performing maintenance on a sectional door. The method comprises releasing tension from a tension cable coupled with a sectional door; sliding a bottom bracket attached to the cable from a tensioned position to an untensioned position to align a fastener that secures the bottom bracket to the sectional door from a tool-inaccessible portion to a tool-accessible portion in a slot located on the bottom bracket; and loosening the fastener with a tool to remove the bottom bracket from the sectional door.

### BRIEF DESCRIPTION OF THE DRAWINGS

In drawings which illustrate non-limiting embodiments of the invention,

FIG. 1 shows a perspective view from the interior of a sectional door assembly with a pair of bottom brackets installed in the lower left and right corners of the bottom section of the door.

FIG. 2 shows a safety bottom bracket according to an example embodiment of the invention.

FIG. 3 shows the safety bottom bracket of FIG. 2 in a partially installed position.

FIG. 4 shows a safety bottom bracket according to an alternative embodiment of the invention.

FIGS. 5-8 are schematic drawings of some alternative configurations of protrusion(s) on a safety bottom bracket.

FIG. 9 shows a safety bottom bracket according to an alternative embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

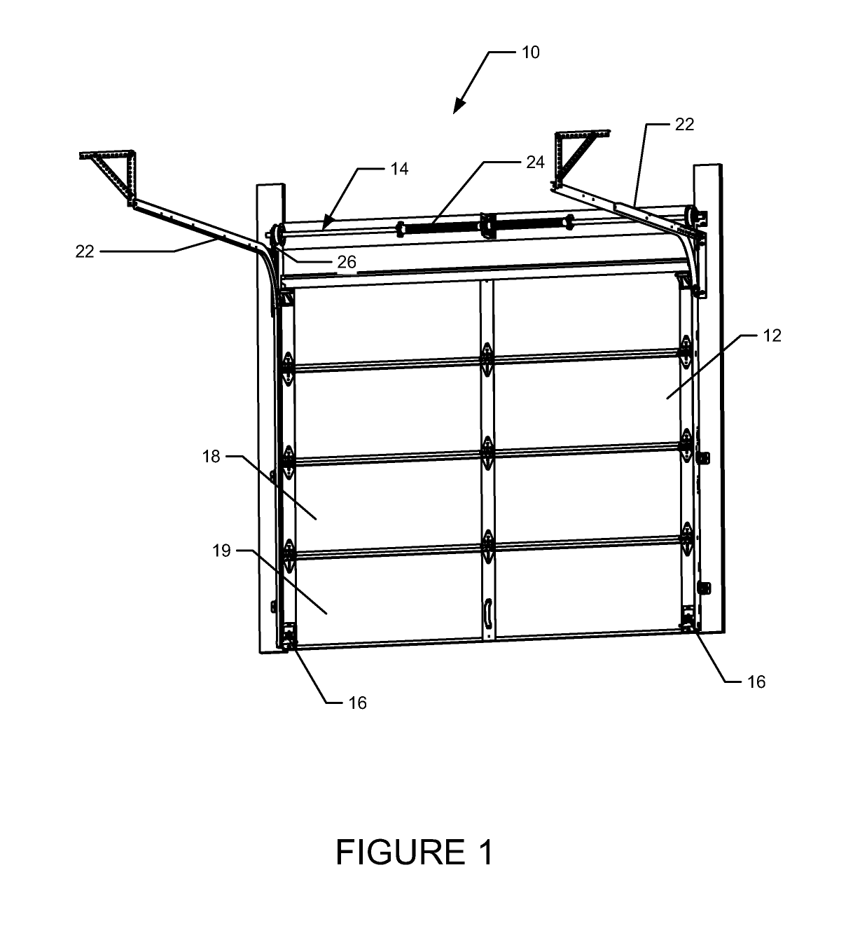

FIG. 1 shows a sectional door assembly 10 comprising a sectional door 12, a counterbalance system 14 and a pair of bottom brackets 16 installed on the lower left and right corners of the sectional door 12. The sectional door 12 may be a garage door or a door installed for other industrial, agricultural or residential purposes.

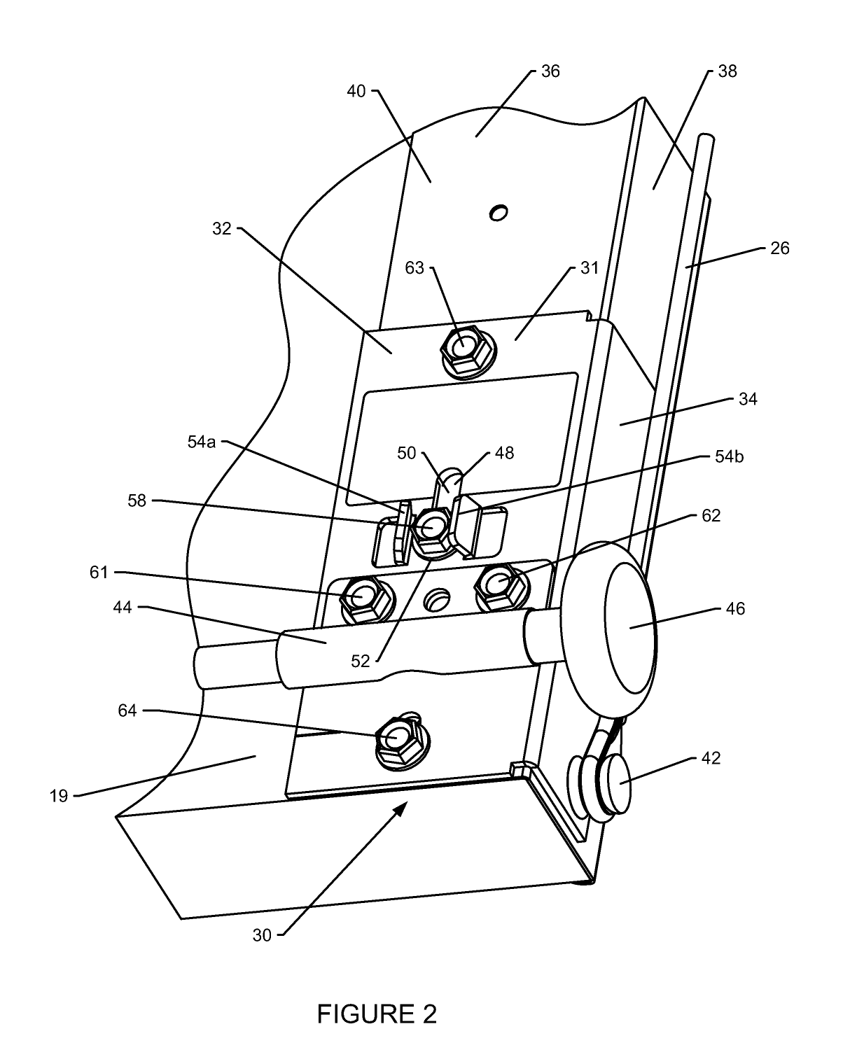

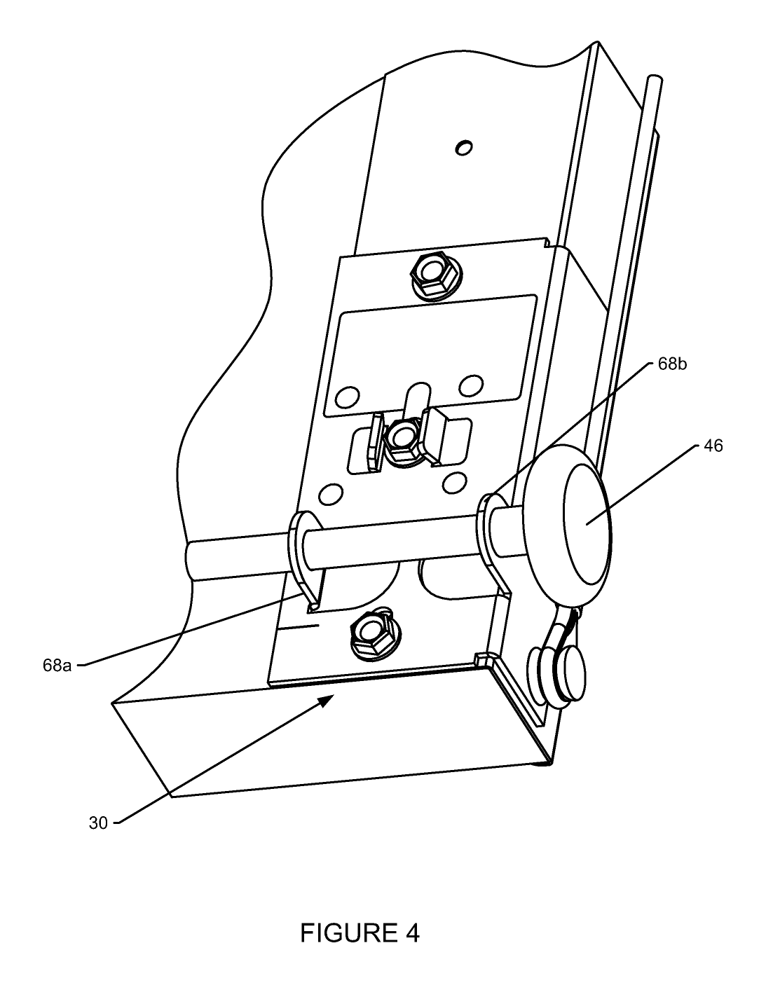

The sectional door 12 has a plurality of interconnected sectional door panels 18, including a bottom panel 19. The sectional door assembly 10 is provided with a plurality of rollers (not clearly visible in FIG. 1, but a roller mounted on a bottom bracket is shown in FIGS. 2 and 4) rotatably attached near and extending beyond the side edges of the panels 18. The sectional door 12 is movable between open and closed positions. The rollers are rollably received in a pair of opposed tracks 22 to guide the sectional door 12 between its open and closed positions.

The counterbalance system 14 applies an upward force to the sectional door 12 by application of a spring force to the sectional door 12. The counterbalance system 14 comprises one or more springs 24 and a pair of cables 26 attached to the springs 24. Each cable 26 is connected to one of the bottom brackets 16. The springs 24, which may be extension springs or torsion springs, operatively tension the cables 26 which in turn pull on the bottom bracket 16 and thus the sectional door 12. The bottom bracket 16 in FIG. 1 may be a conventional bottom bracket or a safety bottom bracket of the present invention. Example embodiments of the safety bottom bracket of the present invention are described in greater details below with further reference to FIGS. 2-9.

FIG. 2 shows a bottom bracket 30 according to one example embodiment of the invention in an assembled and tensioned position. The bottom bracket 30 comprises a frame 31. In the FIG. 2 embodiment, the frame 31 comprises a back planar surface 32 and a side planar surface 34, and the side planar surface 34 extends substantially vertically from an edge of the back planar surface 32. The bottom bracket 30 overlays a part of a back 36 and a side 38 of an end stile 40 which is fixedly secured to the bottom panel 19 of the sectional door. The bottom bracket 30 can be secured to the end stile 40. Alternatively, the bottom bracket 30 can be secured directly to the bottom panel 19 without use of the end stile 40.

A cable attachment member 42 is provided on frame 31 of the bottom bracket 30 for attaching the cable 26 to the bottom bracket 30. In the FIG. 2 embodiment, the cable attachment member 42 is coupled to the side planar surface 34. It should be recognized that the cable attachment member 42 may be coupled to the back planar surface 32. The cable attachment member 42 may comprise an elongated body with an enlarged head. In some embodiments, the cable attachment member 42 may comprise a rivet. In some embodiments, the cable attachment member 42 may comprise a clevis type fastener.

A roller mount 44 (or equivalent device) is provided for attaching a roller 46 to the bottom bracket 30. In the FIG. 2 embodiment, the roller mount 44 is attached to the frame 31 by means of fasteners 61, 62. Additional fasteners 63, 64 are used to further secure the bottom bracket 30 to the end stile 40 and/or the sectional door. A plurality of apertures are provided on the bottom bracket 30 for receiving these fasteners 61, 62, 63, 64.

In the FIG. 2 embodiment, the bottom bracket 30 comprises a slot 48 located in the back planar surface 32 of the frame 31. However, in other embodiments, the slot 48 may be located in the side planar surface 34 of the frame 31. The slot 48 comprises a tool-accessible portion 50 and a tool-inaccessible portion 52. In the FIG. 2 embodiment, protrusions 54a, 54b are provided on or near the side edges of the tool-inaccessible portion 52 of the slot 48 to impede the access of a tool (e.g., a wrench) to the tool inaccessible portion 52 of the slot 48. It should be recognized that instead of having a single slot 48, two or more slots may be provided in the bottom bracket, and each one of these slots may have a tool-inaccessible portion that is flanked with protrusions. In some embodiments, protrusions 54a, 54b may be substantially perpendicular or vertical to the back planar surface 32. In some embodiments, protrusions 54a, 54b may be tilted toward the slot 48. It is also possible that in some embodiments the protrusions 54a, 54b are tilted away from the slot 48. In some embodiments, extension members may be provided on the protrusions which extend laterally from protrusions.

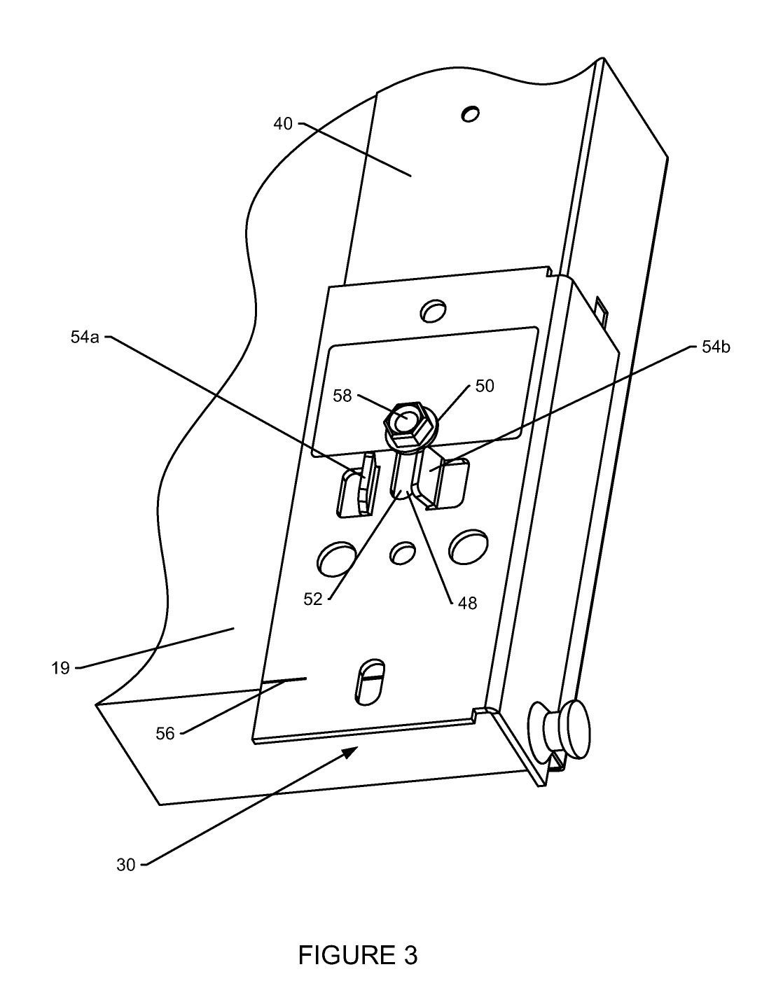

FIG. 3 shows the bottom bracket 30 of FIG. 2 in a partially assembled and untensioned position. As shown in FIG. 3, bottom bracket 30 is aligned with a bottom edge of door panel 19 using an alignment means 56 on bottom bracket 30. The alignment means 56 may be a mark, a bump, a depression, a notch, or a hole, or combinations thereof. The alignment means 56 can be created by a number of suitable methods, including, but not limited to, stamping, embossing, piercing, scribing, welding, and labeling. A fastener 58 is assembled through the tool-accessible portion 50 of slot 48 and into the sectional door. Depending on the construction materials of the sectional door, fastener 58 is most commonly driven through the bottom bracket 30 and into the end stile 40 of the sectional door. Once fastener 58 is installed, bottom bracket 30 may then be slidably moved upwards into its final installed position as shown in FIG. 2. The action of moving the bottom bracket 30 upwards results in the protrusions 54a, 54b to be located adjacent to the previously installed fastener 58 as shown in FIG. 2. After locating the bottom bracket 30 in its final position, the assembly is then completed by installing the roller mount 44, the roller 46, the cable 26 and additional fasteners 61, 62, 63, 64 as shown in FIG. 2. In this installed position, protrusions 54a, 54b impede the access of a tool (e.g., a wrench) to the fastener 58.

The embodiment shown in FIG. 2 utilizes a removable roller mount 44. In other embodiments, the roller mount may be integrated with the bottom bracket. For example, the embodiment shown in FIG. 4 provides integrated pierced protrusions 68a, 68b extending from the bottom bracket 30. The pierced openings of protrusions 68a, 68b receive the stem of the roller 46. As will be apparent to those skilled in the art, there is no limit to alternative configurations that may be used to assemble the roller to the bottom bracket.

As illustrated in FIG. 2, for situations where the roller needs to be repaired or replaced, an individual may access the fasteners 61, 62 to remove the roller mount 44. As such, the roller 46 may be safely removed from the bottom bracket 30 without releasing cable tension.

If more extensive maintenance is required, the cable tension must be released for safe maintenance of the door. An individual may remove fasteners 61, 62, 63, 64, but protrusions 54a, 54b function to inhibit or prevent any access to the fastener 58. After tension is released from the spring counterbalance system, the cable will become slack. This allows the bracket to be slidably moved downward from the tensioned position in FIG. 2 to the untensioned position in FIG. 3, which in turn aligns the fastener 58 in the slot 48 from the tool-inaccessible portion 52 to the tool-accessible portion 50 and permits an individual easy tool access to the fastener 58.

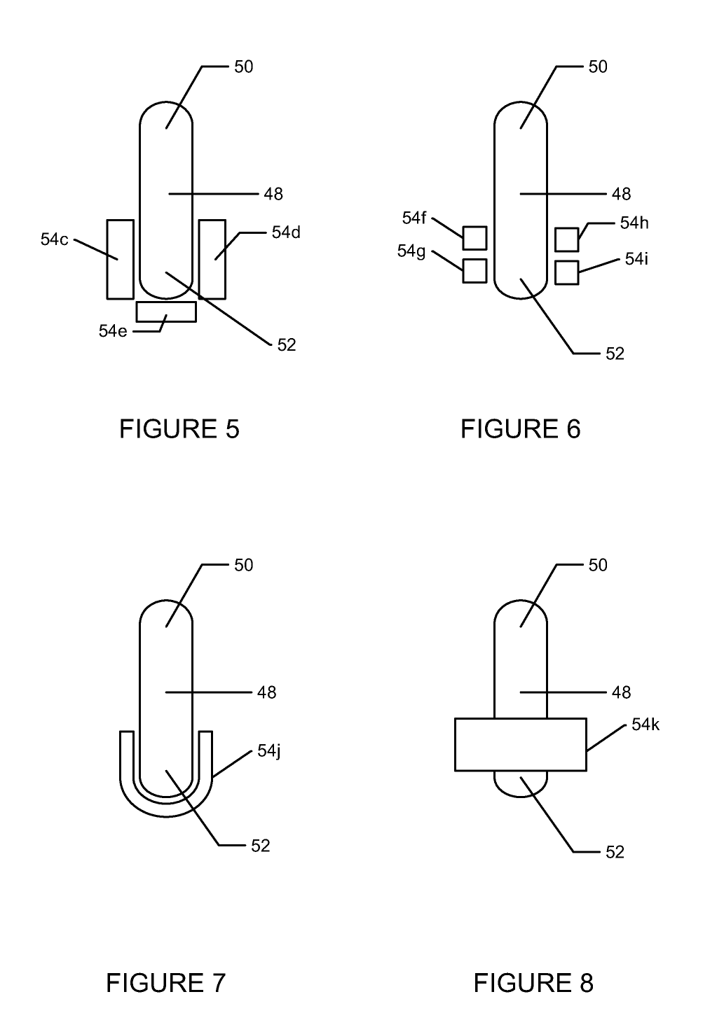

FIGS. 5-8 are schematic drawings illustrating a number of alternative configurations of the protrusion(s) on the safety bottom bracket. In FIG. 5, the protrusions comprise protrusions 54c on the left side of the tool-inaccessible portion 52 of the slot 48, a protrusion 54d on the right hand side of the tool-inaccessible portion 52 of the slot 48, and a protrusion 54e on the bottom side of the tool-inaccessible portion 52 of the slot 48. In FIG. 6, the protrusions comprise a plurality of protrusions 54f, 54g on the left side of the tool-inaccessible portion 52 of the slot 48 and a plurality of protrusions 54h, 54i on the right hand side of the tool-inaccessible portion 52 of the slot 48. In FIG. 7, the protrusion comprises a single U-shaped protrusion 54j that extends around the tool-inaccessible portion 52 of the slot 48. In FIG. 8, the protrusion comprises a bridging piece 54k that comprises two arms extending substantially perpendicularly from both sides of the tool-inaccessible portion 52 of the slot 48 and a connecting piece that spans over the tool-inaccessible portion 52 of the slot 48. As will be apparent to those skilled in the art, there are further alternative configurations of the protrusion(s) that may be used.

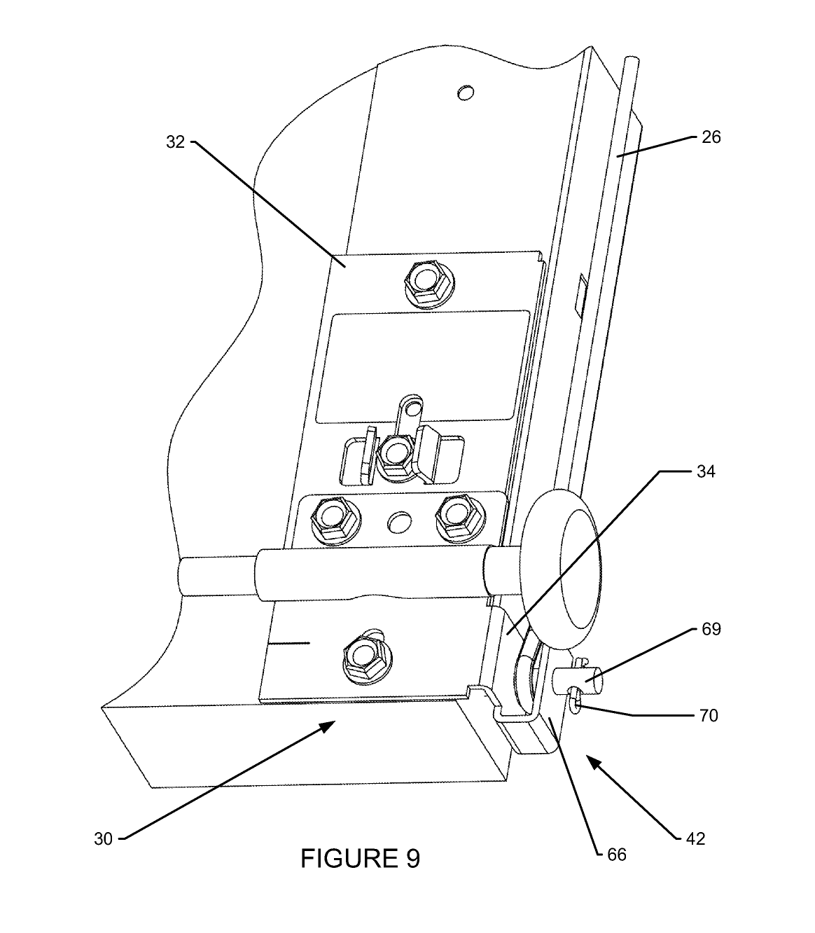

FIG. 9 shows a safety bottom bracket 30 according to another example embodiment of the invention. The FIG. 9 embodiment is similar to the FIG. 2 embodiment, but is different from the FIG. 2 embodiment as follows. In the FIG. 9 embodiment, the cable attachment member 42 of the safety bottom bracket 30 comprises a clevis type fastener. The clevis type fastener includes a clevis 66, a clevis pin 69 and a cotter pin 70. Cable 26 is releasably attached to cable attachment member 42 by the interaction of clevis 66, clevis pin 68 and cotter pin 70. In the FIG. 9 embodiment, the side planar surface 34 of frame 31 is much smaller than the back planar surface 32 of frame 31. The side planar surface 34 forms one of the two prongs of the clevis 66. The clevis 66 has apertures for receiving the clevis pin 69, and the clevis pin 69 has a cross-hole for receiving the cotter pin 70. As will be apparent to those skilled in the art, suitable variations of the clevis type fastener as illustrated in FIG. 9 may also be used.

The protrusions on the bottom bracket can be created by a number of suitable methods. For example, the protrusions can be made by a progressive stamping die tooling which punches or pierces the bottom bracket and bends the protrusions into position. This can be done in one single step or in a series of steps. The protrusions can also be made by welding and/or depositing a suitable material (e.g., steel) on one of the surfaces of the bottom bracket to build up or form a protrusion, or by taking small pieces of a suitable material (e.g., steel) and inserting, welding, or riveting them onto the bottom bracket.

As will be apparent to those skilled in the art in the light of the foregoing disclosure, many alterations and modifications are possible in the practice of this invention. Accordingly, the scope of the invention is to be construed in accordance with the substance defined by the following claims.

What is claimed is:

1. A safety bottom bracket for a sectional door comprising:
a frame;
a cable attachment member coupled to the frame for releasably attaching a cable to the bracket; and
a slot in the frame for securing the bracket to the sectional door via a fastener passing through the slot, the slot having a tool-accessible portion and a tool-inaccessible portion,
wherein the tool-inaccessible portion is defined by one or more protrusions extending from or near the edges of the tool-inaccessible portion of the slot.

2. The safety bottom bracket according to claim 1, wherein
when the bracket is connected to the cable under tension, the bracket is biased to a tensioned position where the fastener is located in the tool-inaccessible portion of the slot; and
when the bracket is not under tension or when the bracket is not connected to the cable, the bracket is movable to an untensioned position where the fastener is located in the tool-accessible portion of the slot.

3. The bracket according to claim 1, wherein the frame comprises a back planar surface and a side planar surface extending from an edge of the back planar surface.

4. The bracket according to claim 3, wherein the back planar surface is substantially perpendicular to the side planar surface.

5. The bracket according to claim 3, wherein the cable attachment member is coupled to the back planar surface.

6. The bracket according to claim 3, wherein the cable attachment member is coupled to the side planar surface.

7. The bracket according to claim 3, wherein the slot is on the back planar surface.

8. The bracket according to claim 3, wherein the slot is on the side planar surface.

9. The bracket according to claim 1, wherein the cable attachment member comprises an elongated body and an enlarged head.

10. The bracket according to claim 1, wherein the cable attachment member comprises a rivet.

11. The bracket according to claim 1, wherein the cable attachment member comprises a clevis type fastener.

12. The bracket according to claim 1, comprising a roller mount which is removably connected to the frame for securing a roller to the bracket.

13. The bracket according to claim 1, comprising a roller mount which is integrally connected to the frame for securing a roller to the bracket.

14. The bracket according to claim 1, comprising a pair of pierced protrusions extending substantially vertically from the frame for securing a roller to the bracket.

15. The bracket according to claim 1, comprising additional apertures in the frame besides the slot for removable connection of the bracket to the sectional door.

16. The bracket according to claim 1 having an alignment means on the bracket for guiding the assembly of the bracket to the sectional door.

17. The bracket according to claim 16, wherein the alignment means is a scribe mark.

18. The bracket according to claim 1, wherein the frame has a generally L-shaped cross-section.

19. A sectional door assembly comprising:
a plurality of interconnected sectional door panels;
a pair of tracks for guiding the movement of the sectional door panels;
a plurality of rollers attached to the sectional door panels and rollably received in the tracks;
a pair of safety bottom brackets according to claim 1 fastened to two lower corners of a bottom panel of the sectional door panels;
one or more springs; and
a pair of cables coupled to the springs at one end and coupled to the safety bottom bracket at the other end for moving the sectional door panels between open and closed positions.

20. A method of performing maintenance on a sectional door, the method comprising:
releasing tension from a tension cable coupled with the sectional door;
sliding a bottom bracket attached to the cable from a tensioned position to an untensioned position to align a fastener that secures the bottom bracket to the sectional door from a tool-inaccessible portion to a tool-accessible portion of a slot in the bottom bracket; and
loosening the fastener with a tool to remove the bottom bracket from the sectional door.
